(19) United States
(12) Patent Application Publication
(10) Pub. No.: US 2024/0028985 A1
(43) Pub. Date: Jan. 25, 2024

(54) Sustainable Business Method for Sustainable Energy Delivery

(71) Applicant: Robert R. Tipton, (US)

(72) Inventor: Robert R. Tipton, (US)

(21) Appl. No.: 17/869,726

(22) Filed: Jul. 20, 2022

(51) Int. Cl. G06Q 10/06

(52) U.S. Cl. CPC G06Q 10/06311

(57) ABSTRACT

This application describes how a mutual company business methodology can quickly deliver electricity to individual homes and businesses in a manner that is profitable to all stake holders—consumers, producers, investors, society and the environment. The primary utility of this business method is to provide lower cost, sustainable electricity to small and impoverished consumers bypassing complex business and legal contractual agreements, financing, loans or traditional leasing arrangements. This allows rapid, turnkey sustainable energy for anyone who is able to pay their electric bill and has a suitable location.

This method is based primarily on the prior art of Howard Hughes Sr's Tool Co, The New England Dairy Farmer's Cooperative, telecom and cable companies which offer perpetual leases and numerous mutual insurance companies. Existing patents for leasing of sustainable energy equipment are also listed as prior art.

Under the Hughes Tool Co and telecom methods customers continue to lease their equipment even after it has been paid off. This differs from other leasing methods which require customers to return or buy the equipment at the end of the lease.

Under the cooperative and mutual business methods, the customers are the shareholders of the mutual company and excess revenue is returned to them in the form of discounted rates or dividends. This defends the customer from price gouging and makes them a stake holder in the equipment on their premises.

The business method is:

Investors provide funds to purchase equipment owned and maintained by the mutual company in exchange for shares.

Customers have the mutual company install the equipment on their premises for their use. The mutual company may or may not charge an installation fee or security payment.

The equipment is sized for the customer's current requirements. The leasing fee is set based on the amount of equipment installed. The lease rate is set to be below the cost of the customer's average, estimated electric consumption. Based on US DOE Energy Information Agency data and the authors' own calculations, current wind and solar systems deliver electricity at a life cycle cost below energy purchased from the electric provider. This is primarily because there is no delivery charge which can account for roughly ½ the cost. This means the customer's electric bill drops on the first month and remains constant regardless of usage eliminating the need for metering.

The rates and share values are set so that the cost of equipment is repaid in a period of time chosen by the mutual company. However, the investor continues to get dividends in perpetuity. This makes the investment itself sustainable. If the investor reinvests the dividends to purchase more equipment and shares, their investment and dividends increase proportionately.

Based on the time and amount of the mutual company's equipment the customers possess, the customers also receive shares in the mutual company.

The principals of the mutual company may hold shares and/or receive salary.

The mutual company may apply revenue from the leases to purchase and install more equipment which increases revenue and the number of members in the mutual company.

If desired the mutual company may sell some or all of the electricity generated by the customer. Proceeds from the sale would be counted as revenue and paid out to customers as dividends and/or reinvested by the mutual company.

The mutual company may also choose to use some of the leasing revenue for other purposes—so long as the shareholders agree with this usage. This is particularly important in the later life of the company where little new equipment needs to be installed and this money can be used for the benefit of society.

Due to the long life of sustainable energy equipment the mutual company has the option of making all leases transferable to new lessees who become new members of the mutual company. If the lease is transferred, the accrued shares may stay with the original member of the mutual company even if they no longer possess the equipment.

As with any such company, the company has the right to reclaim equipment due to non-payment or damage in accordance with local laws. This incentivizes the customers to make timely payments.

An illustrative example:

A customer would receive 1 share per KW of generating capacity on their premises every month they make their lease payments. Their ownership in the mutual company increases linearly over time. As the mutual company grows over time and their number of shares increases, it may be that they now get paid to power their own property. In this case they have the option of using this revenue to buy shares in the mutual company as an investor.

An investor purchases equipment which can generate and store 3 KW in return for 1,000 shares. After 4 years their dividends have repaid their investment. After 8 years they have received double their investment or 100% ROI. After 12 years 200% ROI and so forth.

These numbers are provided as an example only and are not specified as part of the business method. Actual numbers will differ.

The primary benefits of this method are:
It is a sustainable business model to match sustainable energy generation.
It allows scalable installation of sustainable energy generation which is limited only by available equipment, customers and funds. This will allow meeting the Paris accords and environmental needs at much higher speed than present methods
It allows poor and middle-class customers to switch to sustainable energy immediately without the need for loans or capital investment. Since most of these consumers cannot raise the funds, this increases the number of customers substantially, especially in poor and rural areas.
The rapid adoption has the benefit of rapid deployment of equipment and concurrent reduction in CO₂ emissions.
The customers have reduced electric bills immediately after installation. There is no amortization period before receiving the gains.
Customers make fixed equipment leasing payments instead of paying fluctuating electric bills.
If the customers power demands increase the mutual company can install more equipment.
The mutual company takes responsibility for maintenance, repair and replacement of equipment thus relieving the customer of the need to be a sustainable energy technician.
Over time the customer's bills are reduced further due to dividends and may eventually make a profit from the equipment on their premises. This is similar to leasing mineral rights for fossil fuel extraction.
Since this method is well suited for poor customers in rural and or primitive locales, they not only save money but receive more reliable power and a better standard of living.
Because sustainable energy generation works best in rural locales, due to its requirement for large amounts of land, this method benefits poor and rural people in multiple ways making them advocates of renewable energy instead of adversaries.
It has been shown that increasing the standard of living of the poor has the side effect of reducing fertility. This contributes to increasing their standard of living and contributes to societal sustainability because of the reduced number of family members who need to be supported.

### PRIOR ART

USPTO Patent Numbers
8,175,964 Systems and methods for financing renewable energy systems
7,904,382 Methods for financing renewable energy systems
7,890,436 Billing and payment methods and systems enabling consumer premises equipment
7,698,219 Methods, systems and agreements for increasing the likelihood of repayments under a financing agreement for renewable energy equipment

1. (canceled)

2. Which is comprised of
1. A mutual company
2. Providing infinite term leases of equipment related to sustainable energy generation
3. Which compensates the members of the mutual company via dividends
4. Where the dividends are computed such that they are less than the customer's electric bill, high enough to repay the installation cost of die equipment a small fraction of the life span of the equipment and high enough to be an attractive investment.
5. With the option of allowing the customers to use the savings on their electric payments to become members in the company.

3. Which operates as a cooperative where individual energy producers sell the energy to the cooperative which then resells it.

4. Which allows sustainable energy equipment with long useful life to be owned and managed by a cooperative on behalf of the small providers who operate die equipment.
